(19) United States
(12) Patent Application Publication
(10) Pub. No.: US 2019/0200637 A1
(43) Pub. Date: Jul. 4, 2019

(54) SPREADABLE FOOD PRODUCT BASED ON CHOCOLATE AND HAZELNUTS, PROCESS AND PLANT FOR PRODUCING SUCH FOOD PRODUCT

(71) Applicant: VENCHI S.P.A., Castelletto Stura (CN) (IT)

(72) Inventor: Massimiliano CAVICCHIOLI, Castelletto Stura (IT)

(73) Assignee: VENCHI S.P.A., Castelletto Stura (CN) (IT)

(21) Appl. No.: 16/311,665

(22) PCT Filed: Jun. 20, 2017
(86) PCT No.: PCT/IT2017/000121

§ 371 Date: Dec. 19, 2018

(30) Foreign Application Priority Data
Jun. 20, 2016 (IT) 102016000063509
Dec. 22, 2016 (IT) 102016000129961

(51) Int. Cl. A23G 1/48; A23G 1/46; A23G 1/36; A23G 1/00; A23G 1/04; A23G 1/56; A23L 25/00; A23L 33/105; B65B 25/00

(52) U.S. Cl. CPC A23G 1/48; A23G 1/46; A23G 1/36; A23G 1/0009; A23V 2002/00; A23G 1/56; A23L 25/30; A23L 33/105; B65B 25/005; A23G 1/042

(57) ABSTRACT

A spreadable food product based on chocolate and hazelnuts is described, comprising hazelnut paste in a weight percentage included between 35% and 40%, sugar in a weight percentage included between 32% and 40%, cocoa powder in a weight percentage included between 9% and 10%, extra-virgin olive oil in a weight percentage included between 7% and 10%; the use of the spreadable food product based on chocolate and hazelnuts is further disclosed, for reducing glycemia and for increasing the dilatation of blood vessels.

The present invention refers to a spreadable food product based on chocolate and hazelnuts, to a process and to a plant for producing such food product, in particular it refers to a spreadable cream.

From searches in the medical field, it is known that dark chocolate having a high percentage of cocoa, for example 85% of cocoa, provides benefic effects to arteria, generating their dilatation through a mechanism for reducing the oxidative stress.

Object of the present invention is providing a spreadable food product based on hazelnuts-enriched chocolate, a process and a plant for producing such food product which allows providing similar benefits to those of dark chocolate to the spreadable product.

The above and other objects and advantages of the invention, as will result from the following description, are obtained with a spreadable food product based on chocolate and hazelnuts, a process and a plant for producing such food product as claimed in the independent claims. Preferred embodiments and non-trivial variations of the present invention are the subject matter of the dependent claims.

It is intended that all enclosed claims are an integral part of the present description.

The present invention will be better described by a preferred embodiment thereof, provided as a non-limiting example, with reference to the enclosed drawings, in which:

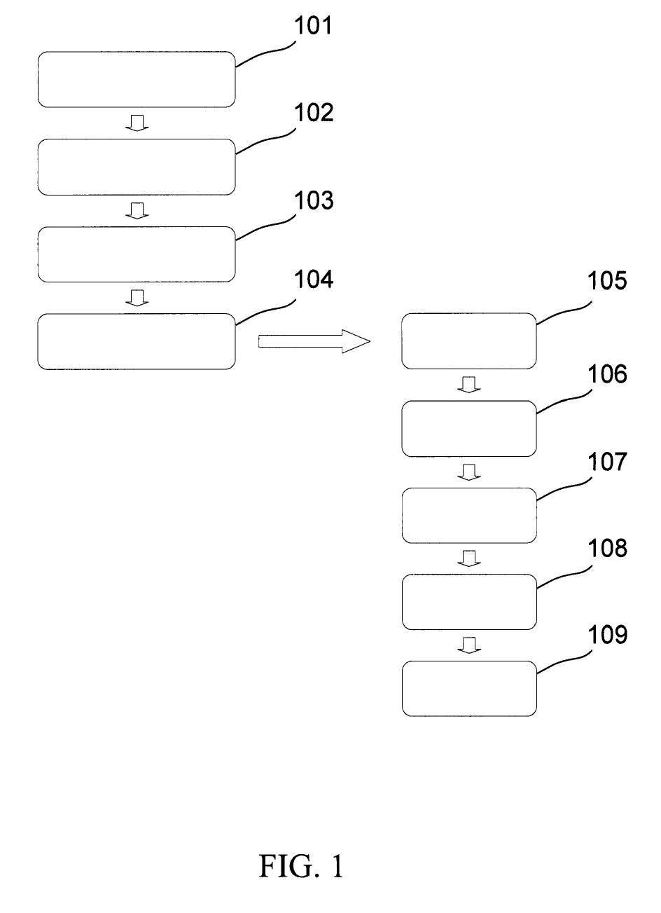

FIG. 1 is a flow diagram of the process for producing the spreadable food product based on chocolate and hazelnuts according to the present invention;

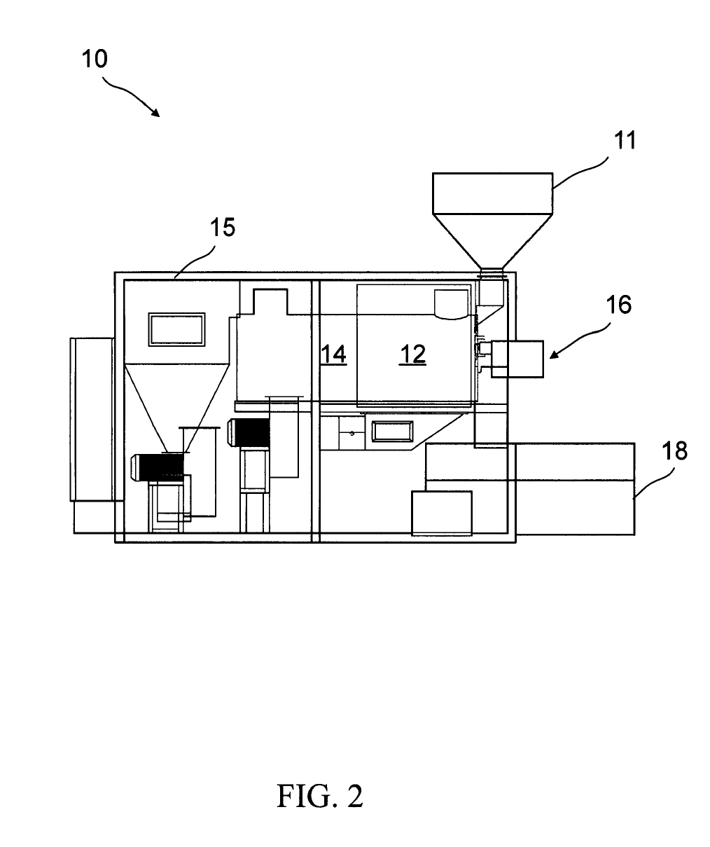

FIG. 2 is a schematic view of a roasting machine of the plant for producing the spreadable food product based on chocolate and hazelnuts according to the present invention;

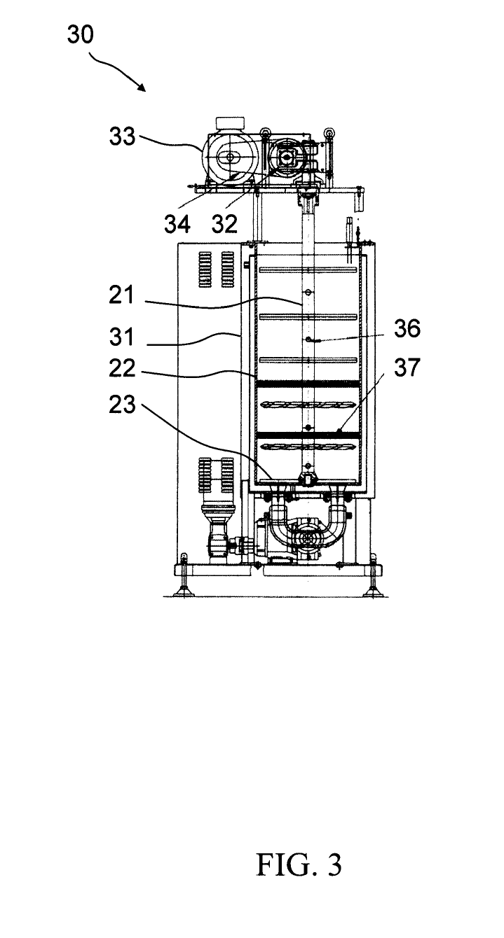

FIG. 3 is a sectional view of a ball mill of the plant for producing the spreadable food product based on chocolate and hazelnuts according to the present invention;

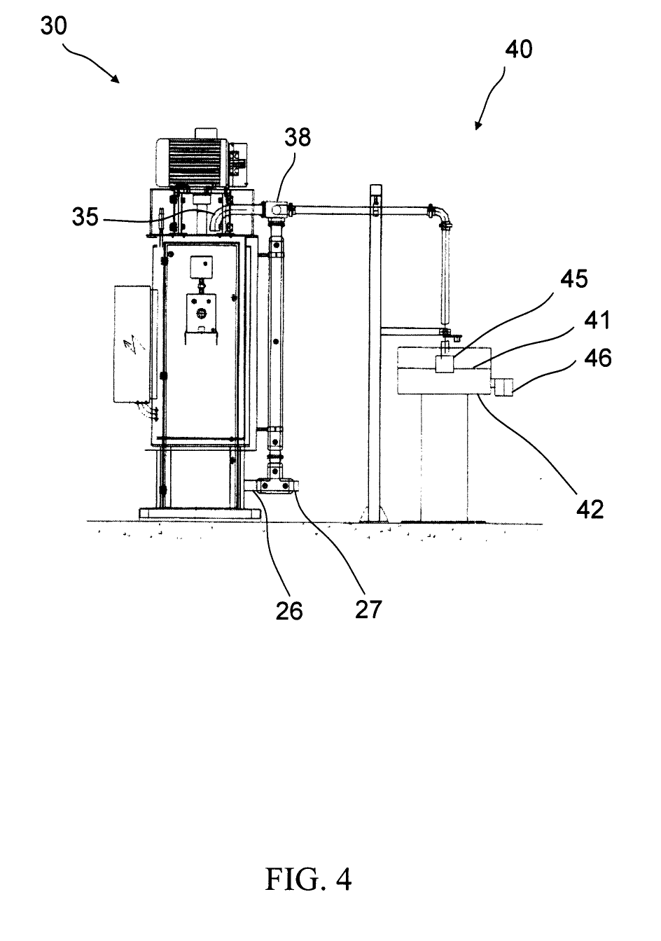

FIG. 4 is a schematic view of a ball mill and of a vibrating sieve of the plant for producing the spreadable food product based on chocolate and hazelnuts according to the present invention;

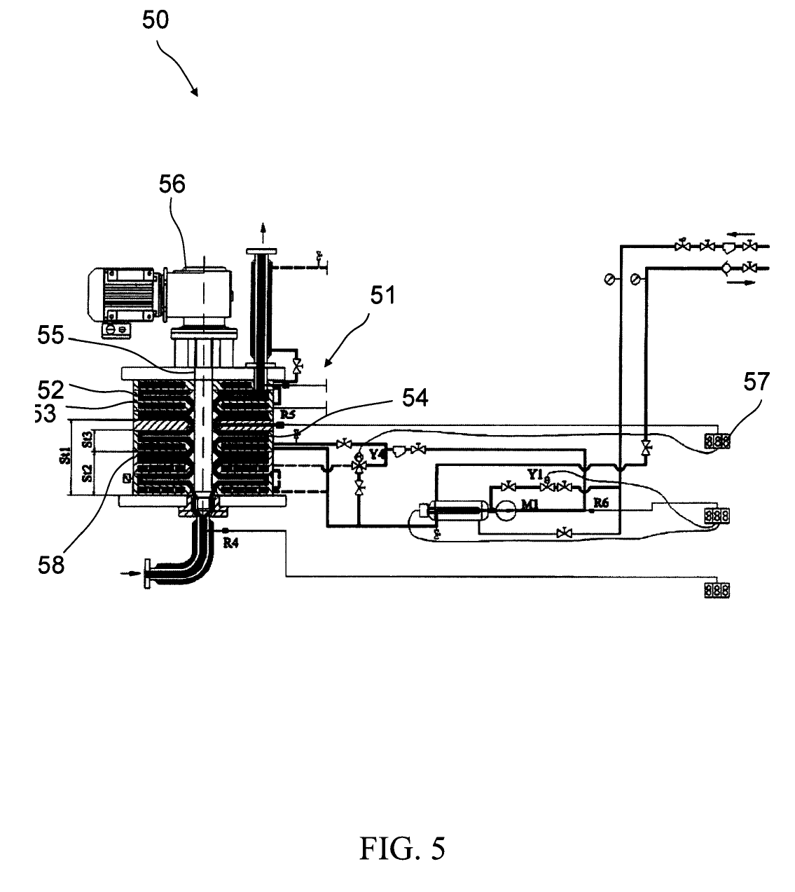

FIG. 5 is a schematic sectional view of a tempering machine of the plant for producing the spreadable food product based on chocolate and hazelnuts according to the present invention; and

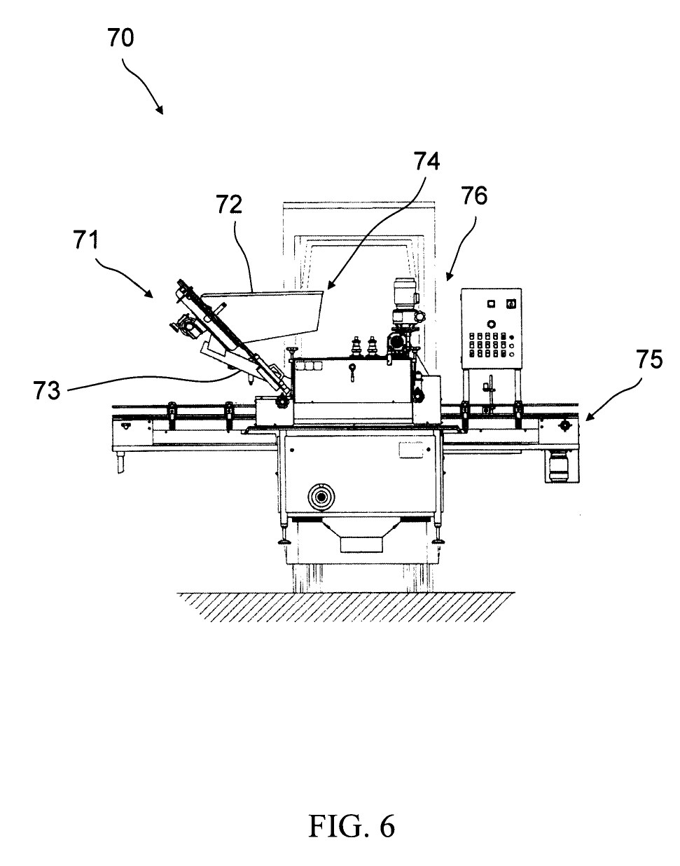

FIG. 6 is a side view of an automatic capsuling machine of the plant for producing the spreadable food product based on chocolate and hazelnuts according to the present invention.

With reference to the Figure, a preferred embodiment of the spreadable food product based on chocolate and hazelnuts, of the process, of the plant for producing such food product of the present invention is shown and described, together with its use for reducing glycemia and for increasing the dilatation of blood vessels. It will be immediately obvious that numerous variations and modifications (for example related to shape, sizes, arrangements and parts with equivalent functionality) can be made to what is described, without departing from the scope of the invention, as appears from the enclosed claims.

Herein below, all stated weight percentages are referred to the total weight of the food product or spreadable cream.

In a first embodiment, the spreadable food product, preferably a spreadable cream, based on chocolate and hazelnuts of the invention comprises the following components:
Hazelnut paste, preferably Piedmont I.G.P.-type hazelnut, in a weight percentage included between 12% and 50%, more preferably in a weight percentage included between 35% and 40%, most preferably in a weight percentage of 37%;
Sugar in a weight percentage included between 15% and 45%, more preferably in a weight percentage included between 32% and 40%, most preferably in a weight percentage of 36%;
Cocoa powder, preferably low-fat cocoa, in a weight percentage included between 4.5% and 12.5%, more preferably in a weight percentage included between 9% and 10%, most preferably in a weight percentage of 9.3%;
Extra-virgin olive oil, in a weight percentage included between 7% and 10%, more preferably in a weight percentage of 7%;

Preferably, the spreadable food product of the invention further contains powder milk in a weight percentage included between 4% and 13%, an emulsifier in a weight percentage included between 0% and 2.5%, and natural flavors in a weight percentage included between 0% and 1%.

In a second embodiment, the spreadable food product, preferably a spreadable cream, based on chocolate and hazelnuts of the invention further comprises the following components:
Whole milk in a weight percentage included between 3% and 25%, preferably in a weight percentage included between 8% and 17%;
Cocoa butter in a weight percentage included between 1% and 20%, preferably in a weight percentage included between 5.5% and 15%;
Cocoa mass in a weight percentage included between 1% and 15%, preferably in a weight percentage included between 1.5% and 10%;
Anhydrous milk fat in a weight percentage included between 0% and 5%, preferably in a weight percentage included between 0.5% and 5%.

With reference to FIG. 1, the process for producing the spreadable food product based on chocolate and hazelnuts of the present invention comprises the following steps:
a step 101 of toasting or roasting the raw hazelnuts through thermal action, which occurs at a temperature between 120° C. and 175° C., for a time included between 15 and 45 minutes; afterwards, the hazelnuts are cooled for a cooling time included between 5 and 15 minutes; the step 101 of toasting or roasting can in turn be divided into three sub-steps:
   a) dehydrating: the humidity content of hazelnuts is reduced which, at their raw state, have a humidity around 6-7%;
   b) temperature increase: the supplied heat (between 120° C. and 175° C.), through hot air coming from a combustion chamber, generates an increase of the product temperature;
   c) pyrolytic step: in this step, between the components of the hazelnuts, chemical processes occur, mainly care of reducing sugars and proteins, which are the base for the formation of volatile substances which confer the classical aroma of roasted product. During this third step of the process, chemical reactions which develop are mainly exothermal;
a step 102 of granulating the roasted hazelnuts in the previous step 101, wherein the roasted hazelnuts are reduced to grains of sizes included between 0.5 and 5 mm, through a physical-mechanical process of reduction to pieces of the hazelnuts; the reduction of hazelnuts into grains is necessary in order to allow the production of hazelnut paste in a following step 103 of grinding/refining and for accelerating the refining step;
the step 103 of grinding/refining the hazelnut grains produced in the previous step 102, in which the hazelnut grains are refined for producing a homogeneous paste of a velvety feeling; the refining process allows obtaining a homogeneous paste wherein lean particles, having size <30 μm, are in suspension in a fat phase (hazelnut oil); the step 103 occurs at a refining temperature included between 25° C. and 65° C. for a refining time included between 50 and 200 minutes;
a step 104 of sieving/filtering, in which the hazelnut paste produced at the end of the previous step 103 is sieved with a thin-mesh sieve of 800 μm; at the end of this step 104, the refined and sieved hazelnut paste is collected and stored at a temperature included between 12° C. and 25° C. till its use.

In the above described steps 101 to 104 of the process for producing the spreadable food product based on chocolate and hazelnuts of the invention, the hazelnuts past is produced, which is used in the following steps, mixed to the other components, for producing the spreadable food product (or spreadable cream) based on chocolate and hazelnuts of the invention, as will be described below in detail.

The process for producing the spreadable food product based on chocolate and hazelnuts of the present invention therefore comprises the following steps:
a step 105 of weighing the components of the spreadable food product (or spreadable cream) based on chocolate and hazelnuts of the invention;
a step 106 of refining, in which the above described components of the cream are mixed and refined at a refining temperature included between 25° C. and 65° C., and for a refining time included between 100 and 250 minutes, to obtain a homogeneous cream, perfectly smooth and of a velvety feeling till the desired refining is reached, with particle size <40 μm.

At the end of this refining step 106, the cream is discharged in a container, making it pass through a filter to keep possible residuals which are not completely refined and possible foreign bodies and, keeping it always stirred, it is cooled down till it reaches a temperature included between 25° C. and 35° C.

Afterwards, there is a tempering step 107 wherein the crystallization process occurs for the lipid fraction of the cocoa contained in the cream, through thermal exchange through conduction between a water chamber and an adjacent chamber containing the cream.

The tempering art consists in inducing the formation of a well determined homogeneous crystalline structure, wherein the presence of thermodynamically more stable crystals is prevailing.

In particular, crystallization nuclei are created, inside a product mass, for the lipid fraction of cocoa before the mass itself is further worked. In a controller process, together with a simultaneous and intense mixing movement, the product is cooled so that inside it the so-called crystallization germs are formed. At a stabilization level, the mass is heated so that unstable crystals are fused and a strong prevalence of stable crystal nuclei remains in the product.

The crystallization process allows guaranteeing the correct storage of the product texture in time, contrasting undesired phenomena such as the separation of the lipid fraction from the non-lipid fraction.

The temperatures of cream and cooling water in the tempering step 107 are as follows:
Input cream temperature from 32° C. to 34° C.;
Tempering temperature from 19° C. to 20° C.;
Cooling water temperature from 10° C. to 12° C.;
Drawing temperature from 20° C. to 20.5° C.;
Maintenance water temperature from 20° C. to 20.5° C.:
Return cream temperature 33° C.;
Return water temperature 40° C.

The process then ends with packaging, which comprises the due steps of filling 108 and of plugging 109.

The step of filling 108 consists in positioning the cream inside containers, preferably composed of glass vases suitable for its storage, and is performed with a cream temperature included between 20° C. and 20.5° C., and the temperature of a loading hopper included between 21° C. and 22° C.

The plugging step 109 consists in closing the container, preferably made of a glass vase closed with a twist-off capsule of the R.T.O. type, which contributes to the storage of the product inside the vase.

The plant for producing the spreadable food product (cream) based on chocolate and hazelnuts of the invention will now be described.

The plant comprises a roasting machine 10, a graining machine, a ball mill 30, a vibrating sieve 40, a tempering machine 50, a batching machine and an automatic capsuling machine 70.

In the roasting machine 10, the roasting step 101 is performed for hazelnuts from raw to roasted through thermal action.

The roasting machine 10 preferably comprises a hopper 11, a roasting drum 12, a cooling tank 18, a combustion chamber 14 with a burner 16 and a film-forming machine 15.

In order to supply the roasting machine 10 with raw products, a hopper 11 made of carbon steel is installed above the roasting drum 12. The product is preferably transported to the hopper through a mechanical lifting device.

The roasting drum 12 is composed of two cylinders, a fixed one and an internal rotating one. The fixed drum is a cylinder made for example of C50 steel, very thick, with an insulated external surface to avoid dispersing heat, closed with a front part and a very thick rear part, for example equal to 20 mm, which support the hubs of the internal rotating drum. On the front part, loading mouths are obtained for raw products and unloading mouths are obtained for roasted products.

In the rotating drum, assembled inside the fixed drum, the product to be roasted is contained. Preferably, the rotating drum is composed of a drilled steel plate to allow circulating the hot air coming from the combustion chamber 14, used for roasting and, simultaneously, the exit of hazelnut films which are detached during the roasting process.

Inside the rotating drum, a series of blades are preferably assembled, with the purpose of keeping the product continuously moving, to allow a better diffusion of heat and obtain an optimum roasting.

In the cooling tank 18, the roasted product is collected, after being unloaded from the roasting drum 12; preferably, the cooling tank 18 is composed of a sturdy steel plate ST 42.2 and is coated with AISI 316 steel, and comprises a plane of drilled plate made of hot AISI 316 stainless steel, whose thickness is 20/10, with holes with a 6-mm diameter, suitable to pass cooling air sucked by a fan connected to the cooling tank 18 through piping. A mixer equipped with rays and mixing devices takes care of keeping the product constantly moving in the cooling tank 18 to enable its cooling.

The combustion chamber 14 is connected to the burner 16 through a steel pipe with big size and is preferably composed of a steel cylinder, with double AISI 310 SH 532 chamber and a hollow space insulated with insulating material resisting up to 1800° C., preferably 10 cm thick, capable of resisting to high temperatures generated by the burner 16 which is assembled in parallel to the roasting drum 12. The external wall of the combustion chamber 14 is suitably insulated, both to avoid heat dispersions, and as accident-preventing measure. The combustion chamber 14 further comprises a rear plate, flanged to allow possible inspections and for cleaning, in which a hole is obtained for housing the burner 16. In the upper part of the combustion chamber 14, an inlet for fumes to be cleaned and an outlet for cleaned fumes are obtained, the fumes being conveyed to a discharge chimney.

The film forming machine 15 has preferably a cylindrical shape, is made of steel plate and with a tapered bottom, with such sizes as not to create a resistance to the air flow of a fan adapted to obtain the separation of the films. Fumes and films coming from the roasting drum 12 enter the film forming machine 15 through a tangential opening obtained in its upper part. Inside, films precipitate towards the tapered bottom, while fumes exit through an upper opening and are conveyed to the combustion chamber 14 to be cleaned.

In the graining machine, the granulating step 102 is performed for roasted hazelnuts through the physical-mechanical process of reduction to pieces of the hazelnuts.

The graining machine is preferably composed of due cutting modules placed in a sequence, which allow dividing the process into two steps, thereby reducing the compression forces and consequently the friction forces which generate thermal energy, thereby keeping the organoleptic features of the product.

In the ball mill 30 the grinding/refining step 103 is performed for hazelnut grains to obtain an eatable cream which is then transferred through heated piping towards the vibrating sieve 40; afterwards, in the ball mill 30 the cream refining step 106 is performed, in which the cream components are mixed and refined to obtain a homogeneous cream.

The ball mill 30 comprises a column body 31, on whose top part the hazelnuts grains are inserted, and is equipped with a stirrer with reels 36 arranged on a central shaft 21 connected to a reducer 32, and with a belt transmission 34 with electric motor 33.

The column body 31 comprises a chamber 22 inside which there are balls 37, preferably made of stainless steel with a 10-mm diameter, in an amount equal to about 40% of the shutter. The movement of the reels 36 and the consequent stirring of the balls 37 makes the product refined and soft.

The mill bottom has a filtering wall 23 communicating with piping 24 connected to a pump 25 which pushes the product towards a duct 26 communicating with a lower discharge outlet 27, a re-circulating deviation 35 and an outlet with solenoid valve 38 for the delivery to a following vibrating sieve 40.

In the vibrating sieve 40, the sieving/filtering step 104 is performed, in which the hazelnut paste is sieved.

The vibrating sieve 40, shown in FIG. 4, comprises a net 41 adapted to divide the product into two types of creams: a finer one which is deposited on an inclined bottom 42 towards a lower outlet 46 and the other one, with bigger grains, which finds its outlet through a side outlet 45 and is possibly re-milled in the ball mill 30.

In the tempering machine 50, the tempering step 107 is performed, wherein the crystallization process of the lipid fraction of cocoa contained in the cream occurs.

The tempering machine 50, shown in FIG. 5, comprises a tempering column 51 comprising overlapped thermal exchange disks 58.

Every thermal exchange disk 58 comprises a water chamber 52, adapted to be crossed by the cooling water, and a product chamber 53, adapted to be crossed by cream to be tempered.

Every product chamber 53 comprises a mixing disk 54 rotatable inside it, connected to a central shaft 55 actuated by a motor-reducer 56 with conical gears placed on the upper part of the tempering machine 50, which is supplied at a reduced pressure.

Preferably the central shaft 55 is equipped with an accessible gasket, and the lower support of this shaft is lubricated by the product itself and therefore do not require any maintenance.

Since the mixing disks 54 do not exert any transport action, the tempering machine 50 is connected to a pump which allows regulating the cream flow-rate, making it flow from bottom to top.

The tempering column 51 comprises a lower cooling level St1 and an upper mixing level St4, shown in FIG. 5; the cooling level St1 is in turn divided into a pre-cooling level St2 and a crystallization level St3; water continuously circulates through the last disk of the cooling level St1; this disk forms the crystallization level St3 and always cools with a 100% load. In this way, with a constant flow-rate of the cream, the same water entry/exit temperatures are guaranteed, in addition to the same cream entry/exit temperatures, so that a constant temperature is reached.

Simultaneously, water from the cooling level St1 is injected in the so-called pre-cooling level St2 through a modulating 3/2 valve Y4 with continuous operation. According to the cooling need, this valve Y4 increases or reduces the cooling water flow-rate in the pre-cooling level St2. Due to the bypass control of the 3/2 valve Y4, no pressure or flow-rate variations occur.

The tempering machine 50 comprises a temperature control system which works in the cooling level St′ with two overlapped regulating circuits. The circulating temperature of the cooling water is regulated together with a probe R6 and a solenoid valve Y1 through a regulator 57.

During the passage of products through the cooling level St1, the temperature variations on the entry side of the product R4 are completely detected by the automatic control. This regulation is automatically adapted should the cream flow-rate change between 50% and 100% of the rated power.

Also in the mixing level St4 water continuously pass through the thermal exchange disks 58.

In this mixing level St4 the product temperature is not regulated, but the circulating water temperature is, to reduce to a minimum the cream temperature variations.

In the batching machine, the filling step 108 of the container is performed.

The batching machine is an automatic machine of a known type, with piston-type batching, adapted to fill cans, bottles, small cylindrical vases, rigid plastic containers, shaped as a frustum-of-cone, a rectangle or a frustum-of-pyramid.

The batching machine is suitable for packaging liquid food products, with medium and high viscosity, pasty, also with parts in suspension. For a correct batching, the product must be homogeneous, without phase separation.

The machine comprises electric motors for the batching machine, the transporter and the stirrer.

Preferably, the external structures are made of AISI 304 stainless steel, while the parts in contact with the product are made of micro-pelletized AISI 304 stainless steel.

The batching machine further comprises a compressed air supply, preferably at 4 bars without lubrication.

The automatic capsuling machine 70 performs the step of plugging 109 or closing the container with a capsule made of ferromagnetic material.

The automatic capsuling machine 70 comprises a magnetic supply 71, equipped with hopper 72 for loading the capsules, and a withdrawal assembly 74 supplied in a continuous and regular way with capsules from the magnetic supply 71 through a connecting chute 73.

The automatic capsuling machine 70 comprises due compressed-air devices adapted to fall the not correctly oriented capsules inside the hopper 72 through an action exerted by two different jets of compressed air. The first air jet is adapted to move away the capsules which are overlapped or inclined, while the second jet enables expelling those capsules which are not correctly oriented.

A timed proximity-switch is installed on the connecting chute 73, and automatically controls the operation of the magnetic supply 71.

Preferably, the connecting chute 73 comprises a series of electric resistances driven by a thermal regulator, adapted to pre-heat the capsules in order to soften the capsule mastic to enable the closing operation.

The automatic capsuling machine 70 further comprises a hinge-type chain for a conveyor belt 75 for transporting the container under the withdrawing assembly 74, and two belts adapted to laterally tighten the container to prevent it from rotating; the withdrawing assembly 74 comprises a guide to keep the capsule in a position in which it is disconnected and withdrawn from the same container during its advancement inside the automatic capsuling machine 70.

The automatic capsuling machine 70 comprises a closing assembly 76 adapted to screw and close the capsule onto the container through two plated belts, a motored plated belt and an idle plated belt, motored through a reducer with worm screw coupled with a motor-variator.

The hinge chain of the conveyor belt 75, internally made of AISI 304, is motored through a reducer with worm screw coupled with a motor-variator.

The operation of the plant according to the present invention will now be described.

Raw hazelnuts are inserted in the roasting machine 10, where the hazelnut roasting step 101 is performed for the process of the invention, during which a reduction of about 8-9% is obtained for the weight of the hazelnuts mass, partly due to the removal of water and partly due to the decomposition of solid substances into volatile components (aromas).

Roasted hazelnuts are then reduced into pieces (grains) by the graining machine which performs step 102 of the process, in its two cutting modules placed in a sequence, which allow dividing the process into two steps.

The hazelnut grains are then loaded in the ball mill 30, inside the column body 31 where the grinding/refining step 103 is performed for the hazelnut grains to obtain the food cream due to the action of the stirrer, with the steel balls 37, which allow refining the grains till the production of a homogeneous paste with velvety feeling. Afterwards, the pump on the bottom of the column body 31 performs the recirculation of the product on the column head, in order to be able to work it to obtain the desired fineness. The hazelnut paste when refining is cooled and heated in a controlled way through the water plant, and is then transferred through heated piping towards the sieve of the vibrating sieve 40 and from this towards collection tanks placed downstream.

In the vibrating sieve 40, the sieving/filtering step 104 is performed, in which the hazelnut paste is sieved, keeping possible non-refined hazelnut residuals and dividing the product into two types of creams: the finer one, which is deposited on an inclined bottom 42 towards a lower outlet 46 and the other one, with bigger grains, which finds its exit through a side outlet 45 and is possibly re-milled in the ball mill 30.

At this time, through the same ball mill 30 used for producing the hazelnuts paste, the step 106 of refining the cream is performed, in which the components of the spreadable food product (cream) based on chocolate and hazelnuts of the present invention are mixed and refined to obtain a homogeneous cream.

All raw materials and semi-finished products, after an accurate weighing, are inserted inside the column body 31 for refining where the action of the stirrer 36 and of the steel balls 37 allow mixing and refining the ingredients, till a homogeneous cream is obtained, perfectly smooth and with velvety feeling.

Also in this case, due to the pump, it is possible to recirculate the cream in the column head, in order to be able to work it till the desired fineness is obtained.

The process of refining the components allows obtaining a homogeneous cream, perfectly smooth and with a velvety feeling.

The thereby obtained cream is placed in a tank connected through a pump with the tempering machine 50, in which the tempering step 107 is performed for crystallizing the lipid fraction of cocoa contained in the cream.

The action of the mixing disk 54 inside each product chamber 53 of the thermal exchange disk 58 allows keeping the homogeneous cream and guaranteeing a uniform distribution of temperatures and consequently the formation of the crystallization nuclei of cocoa butter.

The advancement of the cream through the tempering column 51 occurs from bottom to top through the force generated by the pump.

The cream moves under the mixing disk 54 starting from the center towards the external diameter, penetrates through a slit of the disk upwards and once on the upper side, is transferred to the center of the following disk.

The cream is thereby subjected to an intense movement during the tempering process: due to the special arrangement of the mixing elements and the relatively high number of revolutions, it is possible to obtain a very homogeneous mixing.

The thereby produced cream is inserted in the batching machine, where the container filling step 108 is performed.

The empty containers are manually inserted by an operator on the conveyor belt: in this way, the working cycle starts for the batching machine, at the end of which the containers go out in which the cream is batched according to pre-established parameters.

The container is finally closed by the automatic capsuling machine 70 which performs the step of plugging 109 or closing the container with a capsule made of ferromagnetic material.

The magnetic supplier 71, equipped with hopper 72 for loading the capsules, takes care of selecting and correctly orienting the capsules to supply in a continuous and regular way, through the connecting chute 73, the withdrawing assembly 74.

The not correctly oriented capsules fall inside the hopper 72 through the action exerted by two different jets of compressed air. The first air jet moves away the capsules which are overlapped or inclined on the upper side plate, while the second jet enables the expulsion of not correctly oriented capsules.

The timed proximity switch installed on the connecting chute 73 checks, during its automatic mode, the operation of the magnetic supply 71.

Along the connecting chute 73, the capsules are pre-heated through the electric resistances controlled by the thermal regulator in order to soften the capsule mastic to enable the closing operation.

The container, transported by the hinge chain of the conveyor belt 75, is then laterally tightened by the two belts so that it cannot rotate and is dragged below the withdrawing assembly 74.

The capsule, unmoving and placed on the guide of the withdrawing assembly 74, is unfastened and taken from the same container during its advancement inside the automatic capsuling machine 70.

The container, going on with its advancement, arrives below the closing assembly 76 where, through the two plated belts, screwing and closing the capsule on the container are performed; the closing operation is performed through the combined action of the motored plate belt and of the idle plate belt.

Advantageously, the spreadable food product of the invention allows providing beneficial effects for arteria, in particular generating their dilatation through a mechanism for reducing the oxidative stress.

Advantageously, the spreadable food product of the invention allows obtaining a meaningful reduction of glycemia, reducing the blood glucose level.

Advantageously, the process and the plant for producing the spreadable food product of the invention allow obtaining a homogeneous spreadable cream, perfectly smooth and with a velvety feeling.

Advantageously, the process and the plant for producing the spreadable food product of the invention allow guaranteeing the correct storage of the product texture in time, counteracting undesired phenomena, such as the separation of the lipid fraction from the non-lipid fraction.

Some preferred embodiments of the present invention have been previously shown and described: obviously, the skilled people in the art will immediately devise numerous variations and modifications, functionally equivalent to the previous ones, which fall within the scope of the invention as pointed out by the enclosed claims, in which possible reference signs placed within brackets cannot be interpreted in a limiting way for the claims themselves. Moreover, the word “comprising” does not exclude the presence of elements and/or steps different from those listed in the claims. Article “a” or “an” preceding an element does not exclude the presence of a plurality of such elements. The simple fact that some features are mentioned in the mutually different dependent claims does not mean that a combination of these features cannot be advantageously used.

Further features and advantages of the product according to the invention result from the example which follows.

Purpose of the study is verifying if the consumption of the spreadable food product of the invention generates a dilatation of arteria through down-regulation of the oxidative stress; the blood glucose level has further been measured.

In a randomized study, crossover, in single blind, the following have been measured: a flow-mediated vasodilatation (FMD) on 20 smokers, the oxidized serum LDL (ox-LDL), the generation of nitric oxide (as evaluated from serum levels of nitrites/nitrates (NOx)), the E vitamin and the total polyphenols.

The patients have been administered with 40 g of the spreadable product of the invention (containing 10% of cocoa and 37% of hazelnuts) or g of spreadable control product based on chocolate (containing 10% of cocoa); the above listed variables have been evaluated at basal and 2 hours after ingestion.

After having taken the product of the invention, FMD (from 3.1±3.0 to 7.7±3.8%, p<0.001), Nox (from 53.9±22.6 to 80.5±30.4 μM, p=0.008) and E vitamin (from 4.1±0.7 to 5.2±1.1 μmol/mmol cholesterol, p=0.002) are highly increases, while ox-LDL is strongly decreased (from 42.8±9.0 to 34.6±8.7 U/L, p=0.008); no changes have been observed in these variables after having taken the control product based on chocolate. The total polyphenols in serum increased more after having taken the product of the invention (74.1±9.6 vs 191.9±41.2 mg/L GAE, p<0.001) than after having taken the control (58.4±6.4 at 74.1±9.6 mg/L GAE, p=0.029).

These results provide the first evidence that the spreadable food product based on chocolate and hazelnuts of the invention has vasodilating properties through an oxidative stress mechanism.

A surprising result of the study has been the strong reduction of the glucose level in blood after having taken the spreadable food product based on chocolate and hazelnuts of the invention.

Conclusions: this study demonstrates that the food product based on chocolate and hazelnuts of the invention improves FMD, with a mechanism which potentially involves down-regulation of the oxidative stress and, finally, has increased the generation of NO in smokers.

A strong reduction of glycemia (blood glucose level) has also been observed.

1. A spreadable food product based on chocolate and hazelnuts comprising:
Hazelnut paste in a weight percentage included between 35% and 40%;
Sugar in a weight percentage included between 32% and 40%;
Cocoa powder in a weight percentage included between 9% and 10%; and
Extra-virgin olive oil in a weight percentage included between 7% and 10%.

2. The spreadable food product based on chocolate and hazelnuts according to claim 1, characterized in that it comprises:
Hazelnut paste in a weight percentage of 37%;
Sugar in a weight percentage of 36%;
Cocoa powder in a weight percentage included between 7.5% and 9.5%;
Powder milk in a weight percentage of 9.3%;
Extra-virgin olive oil in a weight percentage of 7%.

3. The spreadable food product based on chocolate and hazelnuts according to claim 1 or 2, characterized in that it further comprises:
Powder milk in a weight percentage included between 4% and 13%;
Emulsifier in a weight percentage included between 0% and 2.5%; and
Natural flavor in a weight percentage included between 0% and 1%.

4. Use of the spreadable food product based on chocolate and hazelnuts according to claim 1 for reducing glycemia.

5. Use of the spreadable food product based on chocolate and hazelnuts according to claim 1 for increasing the dilatation of blood vessels.

6. Process for producing the spreadable food product based on chocolate and hazelnuts according to claim 1, characterized in that it comprises the following steps:
a step (101) of toasting or roasting raw hazelnuts through thermal action;
a step (102) of granulating the roasted hazelnuts in the previous step (101), wherein the roasted hazelnuts are reduced to grains through a physical-mechanical process of reduction of the hazelnuts into pieces;
a step (103) of grinding/refining the hazelnut grains produced in the previous step (102), in which the hazelnut grains are refined for producing a homogeneous paste wherein lean particles are in suspension in a fat phase;
a step (104) of sieving/filtering, in which the hazelnut paste produced at the end of the previous step (103) is sieved with a thin-mesh sieve;
a step (105) of weighing components of the spreadable food product based on chocolate and hazelnuts;
a step (106) of refining, in which the components of the spreadable food product are mixed and refined to obtain a homogeneous cream; and
a step of tempering (107) wherein a crystallization process occurs for the lipid fraction of the cocoa contained in the spreadable food product, through thermal exchange to induce formation of a homogeneous crystalline structure in the product.

7. The process for producing the spreadable food product based on chocolate and hazelnuts according to claim 6, characterized in that the step (101) of toasting or roasting comprises the following sub-steps:
dehydrating, in which the humidity content of the hazelnuts is reduced;
temperature increasing, through heat supplied by hot air coming from a combustion chamber; and
pyrolytic step, in which between the components of the hazelnuts chemical processes occur based on the formation of volatile substances which confer aroma to the product.

8. The process for producing the spreadable food product based on chocolate and hazelnuts according to claim 6, characterized in that:
the step (101) of toasting or roasting raw hazelnuts occurs at a temperature between 120° C. and 175° C., for a time included between 15 and 45 minutes, with a following cooling of the hazelnuts for a cooling time included between 5 and 15 minutes;
the step (102) of granulating the hazelnuts reduces the roasted hazelnuts into grains of sizes included between 0.5 and 5 mm;
the step (103) occurs at a refining temperature included between 25° C. and 65° C. for a refining time included between 50 and 200 minutes to obtain a homogeneous paste wherein lean particles, having size <30 μm, are in suspension in a fat phase;
the step (104) of sieving/filtering is performed with a thin-mesh sieve of 800 μm;
the step (106) of refining occurs at a refining temperature included between 25° C. and 65° C., and for a refining time included between 100 and 250 minutes, to obtain a cream with particle size <40 μm; and
the step of tempering (107) occurs with the following temperature of the spreadable food product and the cooling water:
Input product temperature from 32° C. to 34° C.;
Tempering temperature from 19° C. to 20° C.;
Cooling water temperature from 10° C. to 12° C.;
Drawing temperature from 20° C. to 20.5° C.;
Maintenance water temperature from 20° C. to 20.5° C.;
Return product temperature 33° C.;
Return water temperature 40° C.

9. A plant for producing the spreadable food product based on chocolate and hazelnuts according to claim 6, characterized in that the plant comprises:
a roasting machine (10) wherein the step (101) of roasting the hazelnuts is performed;
a graining machine wherein the step (102) of granulating the roasted hazelnuts is performed;
a ball mill (30) wherein the step (103) of grinding/refining the hazelnut grains and the step (106) of refining the product are performed;
a vibrosieve (40) wherein the step (104) of sieving/filtering is performed;
a tempering machine (50) wherein the step of tempering (107) is performed;
a batching machine wherein a step of filling (108) the container is performed; and
an automatic capsuling machine (70) wherein a step of plugging (109) or closing the container is performed.
